(19) United States
(12) Patent Application Publication
(10) Pub. No.: US 2002/0130981 A1
(43) Pub. Date: Sep. 19, 2002

(54) Monitor assembly with an inclination-adjustable monitor unit

(75) Inventors: Chih-Peng Ma, Taipei City (TW); Yu-Shin Chuo, Taipei City (TW)

Correspondence Address: Stephen A. Bent, FOLEY & LARDNER, Washington Harbour, 3000 K Street, N.W., Suite 500, Washington, DC, 20007-5109, US

(73) Assignee: COMPAL ELECTRONICS, INC.

(21) Appl. No.: 09/850,133

(22) Filed: May 8, 2001

(30) Foreign Application Priority Data
Mar. 19, 2001 (TW) 090204101

(51) Int. Cl. H04N 5/64

(52) U.S. Cl. 348/843

(57) ABSTRACT

A monitor assembly includes abase, a pivot connector, and a monitor unit. The base has a horizontal base plate portion and an upright stand portion extending upwardly from the base plate portion. The stand portion has an upper end portion and a front side wall formed with an opening at the upper end portion. The stand portion is formed with a first mounting unit within the opening. The pivot connector has a second mounting unit extending into the opening and mounted securely on the first mounting unit, and a pivot unit connected pivotally to the second mounting unit. The monitor unit has a rear casing member formed with a third mounting unit that is mounted securely on the pivot unit of the pivot connector.

### BACKGROUND OF THE INVENTION

1. Field of the Invention

The present invention relates to a monitor assembly, more particularly to a monitor assembly having a monitor unit with an adjustable inclination relative to a base.

2. Description of the Related Art

A monitor assembly having a monitor unit with an adjustable inclination is known in the art. FIG. 1 illustrates a conventional monitor assembly of this type. The conventional monitor assembly includes a liquid crystal display monitor unit 8 which is mounted on a base 7 by means of a pivot connector 6 and an adjustable rod unit 9. The pivot connector 6 has a lower end portion connected pivotally to the base 7, and an upper end portion 61 engaging the monitor unit 8. The adjustable rod unit 9 includes a female screw rod 92 having a rear end pivoted to the base 7, and an open front end engaging threadedly a male screw rod 91 which has a front end abutting against a rear side surface of the pivot connector 6 at a point between the lower and upper end portions of the pivot connector 6. The male screw rod 91 is operable for threading inwardly or outwardly relative to the female screw rod 92 so as to permit adjustment in the inclination of the monitor unit 8.

However, since the male and female screw rods 91, 92 are typically made of metal and are exposed from the base 7, the conventional monitor assembly does not have a tidy appearance.

### SUMMARY OF THE INVENTION

Therefore, the main object of the present invention is to provide a monitor assembly having an inclination-adjustable monitor unit and a concealed pivot connector for mounting the monitor unit pivotally and adjustably on a base.

Accordingly, the monitor assembly of the present invention includes a base, a pivot connector, and a monitor unit. The base has a horizontal base plate portion and an upright stand portion extending upwardly from the base plate portion. The stand portion has an upper end portion and a front side wall formed with an opening at the upper end portion. The stand portion is formed with a first mounting unit within the opening. The pivot connector has a second mounting unit extending into the opening and mounted securely on the first mounting unit, and a pivot unit connected pivotally to the second mounting unit. The monitor unit has a rear casing member formed with a third mounting unit that is mounted securely on the pivot unit of the pivot connector.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary perspective view of a conventional monitor assembly;

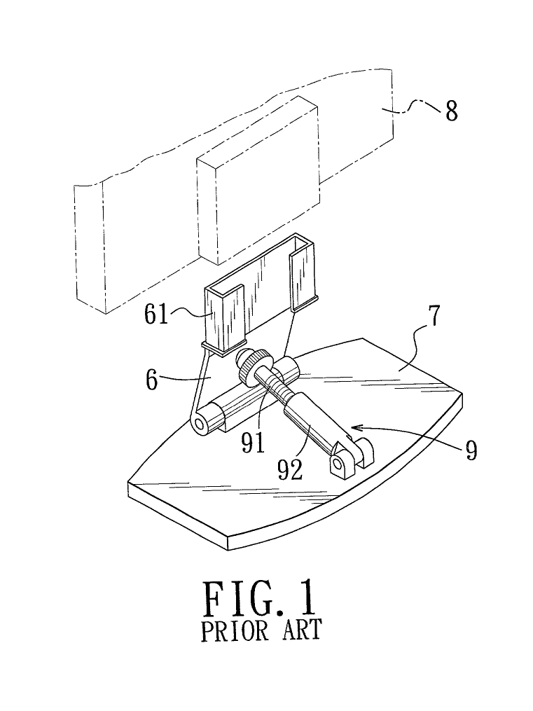

FIG. 2 is an exploded perspective view of a base and a pivot connector of a preferred embodiment of a monitor assembly of the present invention, viewed from a front side of the base;

FIG. 3 is another exploded perspective view of the base and the pivot connector, viewed from a rear side of the base;

FIG. 4 is an exploded perspective view of a monitor unit of the monitor assembly of the present invention, viewed from a rear side of the monitor unit;

FIG. 5 is a perspective view of an anchoring plate of the monitor unit of FIG. 4, viewed from a front side of the anchoring plate;

FIG. 6 is a perspective view illustrating the base of the monitor assembly of the preferred embodiment when mounted with the pivot connector;

FIG. 7 is an assembled rear perspective view of the monitor unit;

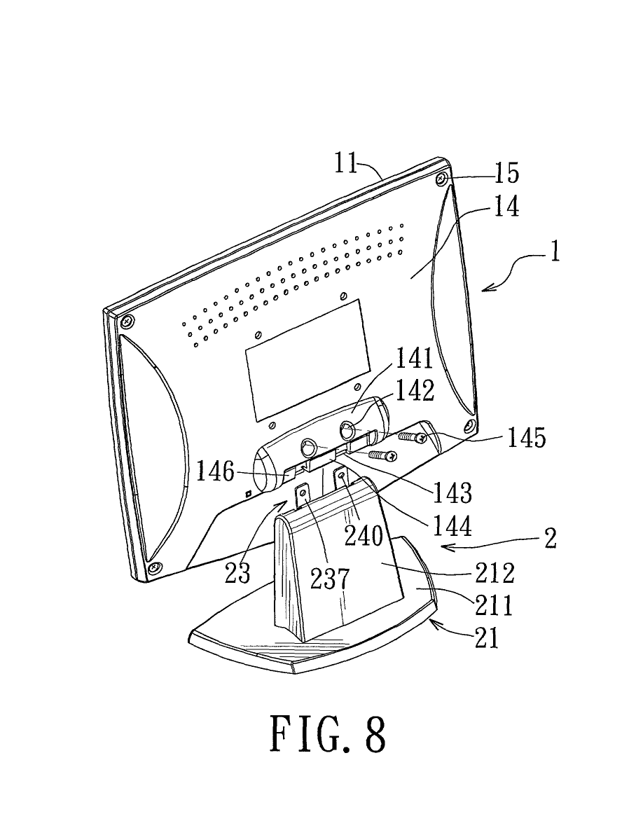

FIG. 8 illustrates how the monitor unit is mounted on the base after the pivot connector is assembled to the base; and FIG. 9 is an assembled rear perspective view of the monitor assembly.

### DETAILED DESCRIPTION OF THE PREFERRED EMBODIMENT

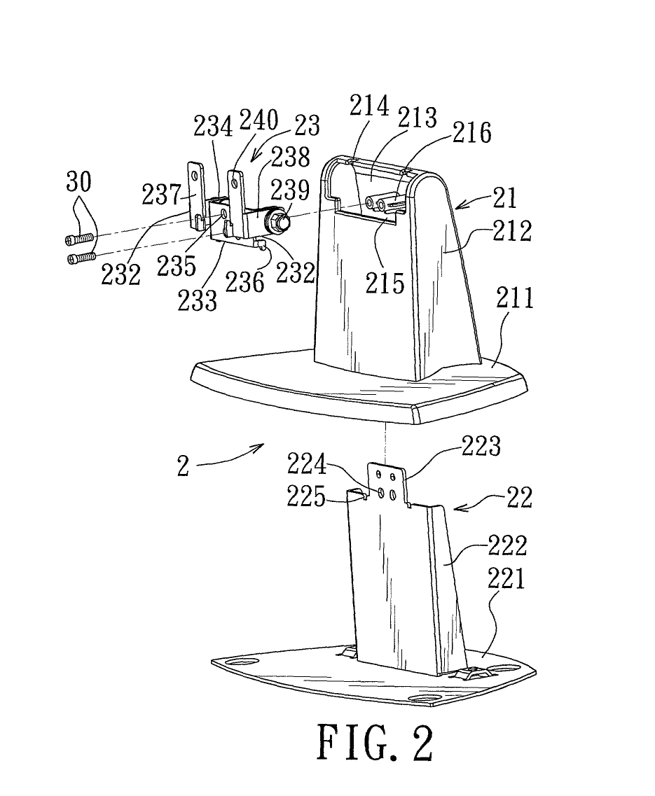

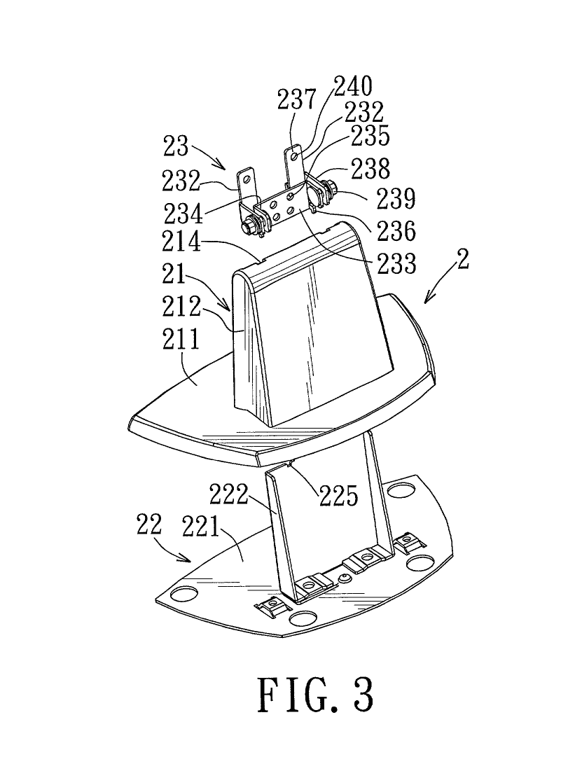

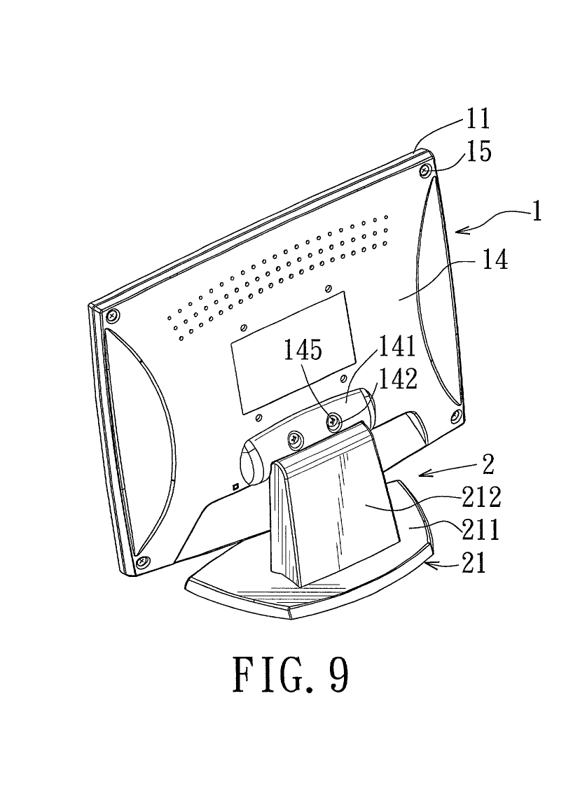

Referring to FIGS. 8 and 9, the preferred embodiment of the monitor assembly according to the present invention is shown to include a monitor unit 1, a base 2, and a pivot connector 23 for mounting the monitor unit 1 pivotally on a front side of the base 2. Referring to FIGS. 2 and 3, the base 2 includes an inner support 22 and an outer casing 21. The inner support 22 has a horizontal support plate 221 and an upright post 222 extending upwardly from the horizontal support plate 221. The inner support 22 is formed from a rigid material, such as metal, for providing a sufficient supporting effect. The upright post 22 is formed by bending a metal plate, and has a U-shaped cross-section. The upright post 22 has an upper end formed with a mounting extension 223 which has two pairs of screw holes 224 formed therethrough. The upright post 22 further has an upper edge formed with a pair of positioning grooves 225 on opposite lateral sides of the mounting extension 223. The outer casing 21 has a shape generally corresponding to that of the inner support 22, and includes a wider and shallower lower casing part 211 which opens downwardly and which covers the support plate 221, and a narrower and higher upper casing part 212 which extends upwardly from the lower casing part 211 and which encloses the upright post 222. The lower casing part 212 has a bottom side formed with engaging grooves and projections (not shown) for engaging the support plate 221, and cooperates with the support plate 221 to form a base plate portion of the base 2. The upright stand 222 extends into the upper casing part 212 and cooperates with the upper casing part 212 to form an upright stand portion of the base 2. The upper casing part 212 has an upper end portion with an upwardly curving periphery, and includes front and rear side walls. The front side wall is formed with an opening 213 at the upper end portion. The opening 213 is defined by a looped wall which has a rear wall section that defines a rear periphery of the opening 213 and a front wall section that defines a front periphery of the opening 213. The rear wall section is formed with a pair of rear limiting grooves 214 which are displaced from each other in a first horizontal direction. The front wall section is formed with a downward front limiting groove 215 which extends in the first horizontal direction. Within the opening 213, a pair of female screw rods 216 extend forwardly and horizontally from the rear side wall of the outer casing 21 and are aligned respectively with a lower pair of the screw holes 224 in the mounting extension 223 of the inner support 22.

The pivot connector 23 includes a mounting plate 233 which is formed with two pair of screw holes 235 and has two lateral wing portions 234 that bend rearwardly. The pivot connector 23 further includes a pair of pivot members 232, each of which has a pivot lobe 238 that flanks a respective one of the wing portions 234 and that is pivoted to the respective wing portion 234 by means of a respective threaded pin unit 239 such that the pivot members 232 are pivotable relative to the mounting plate 233 with a predetermined friction force acting therebetween and about a horizontal pivot axis that extends in the first horizontal direction. Each of the pivot members 232 further includes an insert piece 237 which is perpendicular to the pivot lobe 238 and which extends upwardly from the pivot lobe 238. The insert piece 237 is disposed on a front side of the mounting plate 233, and has an upper end formed with a screw hole 240. The mounting plate 233 has a lower end formed with a pair of hook projections 236 for engaging the positioning grooves 225 in the upright post 222 of the inner support 22 so as to align the screw holes 235 in the mounting plate 233 with the screw holes 224 in the mounting extension 223 of the inner support 22 of the base 2.

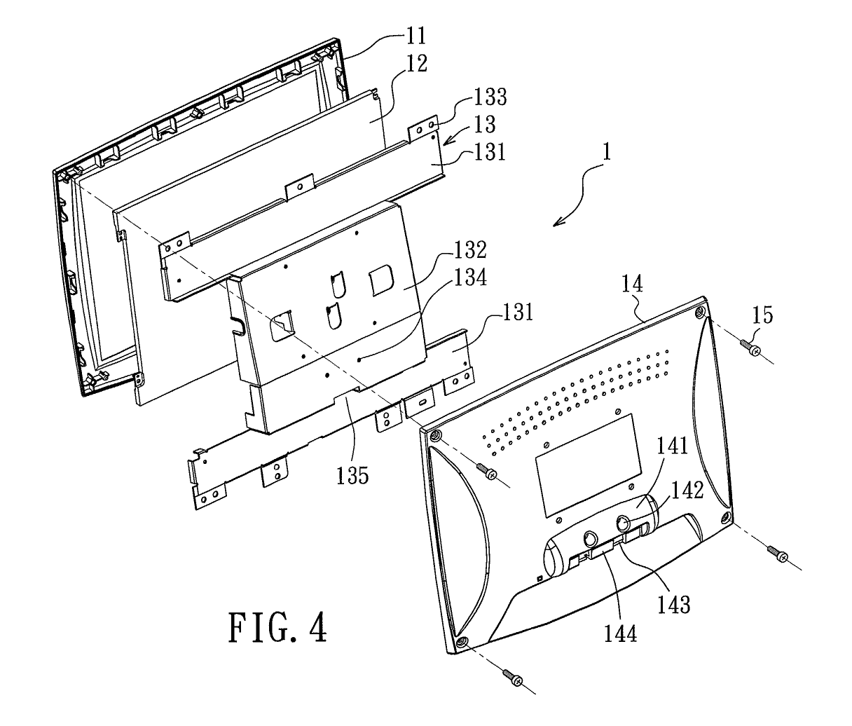

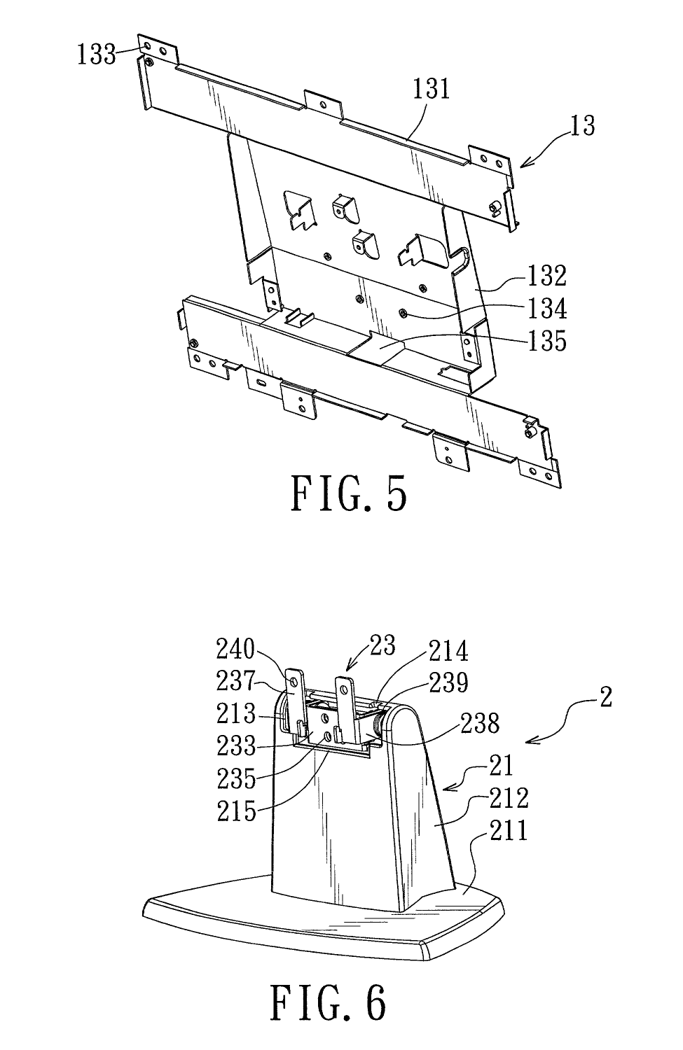

Referring to FIGS. 4 and 5, the monitor unit 1 includes a front panel frame 11, a liquid crystal display (LCD) panel 12 behind the panel frame 11, an anchoring plate 13 behind the LCD panel 12, and a rear casing member 14 which are fastened together with the use of screws 15. The anchoring plate 13 is formed integrally from a rigid material, such as by punching and bending a metal plate. The anchoring plate 13 includes elongated upper and lower mounting parts 131, and a middle anchoring part 132 extending between the upper and lower mounting parts 131. The anchoring part 132 has a rear side surface which inclines downwardly and rearwardly to suit the shape of the rear casing member 14. Each of the upper and lower mounting parts 131 is formed with screw holes 133 for extension of the screws 15 therethrough. The middle anchoring part 132 is formed with a pair of internally threaded screw holes 134, and has a lower edge formed with a rectangular opening 135. The rear casing member 14 has a convex rear side wall with a mounting portion 141 projecting therefrom. The mounting portion 141 has an upper part formed with a pair of fastener holes 142 which are aligned respectively with the internally threaded screw holes 134 in the anchoring plate 13, and a lower part which is formed with a recess 146, a pair of downwardly opening insert slots 143 within the recess 146, and a positioning plate 144 disposed between the insert slots 143. The insert slots 143 permits insertion of the insert pieces 237 (see FIG. 3) of the pivot members 232 thereinto. The positioning plate 144 extends into the rectangular opening 135 in the anchoring plate 13 for positioning the anchoring plate 13 to the rear casing member 14.

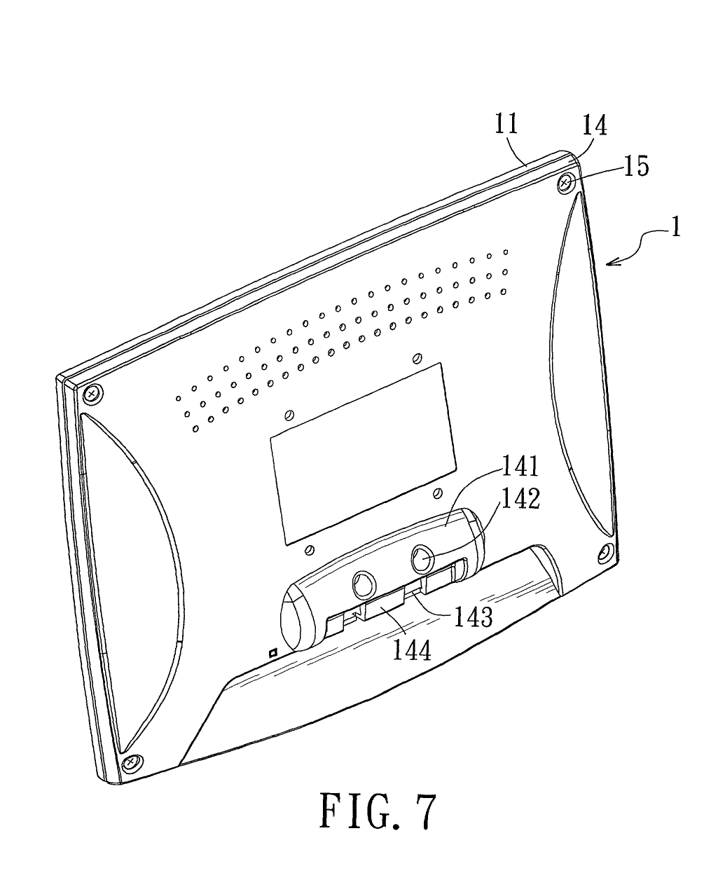

Referring to FIGS. 2, 3, and 6, to mount the pivot connector 23 to the base 2 after the inner support 22 is assembled to the outer casing 21 of the base 2, the pivot connector 23 is extended into the opening 213, allowing the hook projections 236 to engage the positioning grooves 225 of the inner support 22 so as to align the screw holes 235 in the mounting plate 233 respectively with the screw holes 224 in the mounting extension 223 of the inner support 22. A first pair of screw rods 30 are extended through a lower pair of the screw holes 235 in the pivot connector 23 and a lower pair of the screw holes 224 in the inner support 22 of the base 2 and engage threadedly and respectively the female screw rods 216. A second pair of screw rods 30 are extended through an upper pair of the screw holes 235 in the pivot connector 23 and an upper pair of the screw holes 224 in the inner support 22 of the base 2 for fastening together the mounting plate 233 of the pivot connector 23 and the mounting extension 223 of the inner support 22. As shown in FIG. 6, during pivoting movement of the pivot members 232 relative to the mounting plate 233 of the pivot connector 23, the pivot lobes 238 extend respectively into the rear limiting grooves 214 when pivoted to a highest position, and extend into the front limiting groove 215 when pivoted to a lowest position. As such, the pivoting movement of the pivot members 232 can be limited between the rear periphery and the front periphery of the opening 213.

Referring to FIGS. 4, 8 and 9, to mount the monitor unit 1 to the base 2 and the pivot connector 23, the insert pieces 237 of the pivot connector 23 are inserted upwardly into the insert grooves, 143 in the rear casing member 14. A pair of screw rods 145 are extended respectively through the fastener holes 142 in the rear casing member 14, the fastener holes 240 in the insert pieces 237 of the pivot connector 23 and the internally threaded screw holes 134 in the anchoring plate 13 for engaging threadedly the internally threaded screw holes 134.

When the base 2 is mounted on the monitor unit 1 by means of the pivot connector 23, the upper end portion of the outer casing 21 of the base 2 is extended into the recess 146 such that the opening 213 in the outer casing 21 is concealed within the recess 147. The monitor assembly thus has a tidy appearance. In addition, the monitor assembly of the present invention can be easily assembled through the use of the screw rods. The manufacturing process is thus simplified.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A monitor assembly comprising:
a base having a horizontal base plate portion and an upright stand portion extending upwardly from said base plate portion, said stand portion having an upper end portion and a front side wall formed with an opening at said upper end portion, said stand portion being formed with a first mounting unit within said opening;
a pivot connector having a second mounting unit extending into said opening and mounted securely on said first mounting unit, and a pivot unit connected pivotally to said second mounting unit; and
a monitor unit having a rear casing member formed with a third mounting unit that is mounted securely on said pivot unit of said pivot connector.

2. The monitor assembly as claimed in claim 1, wherein said base includes an inner support and an outer casing, said inner support having a horizontal support plate and an upright post extending upwardly from said horizontal support plate, said outer casing having a lower casing part which covers said support plate and which cooperates with said support plate to form said base plate portion, said outer casing further having a upper casing part which encloses said upright post and which cooperates with said upright post to form said stand portion, said upper casing part being formed with said first mounting unit and having said front side wall.

3. The monitor assembly as claimed in claim 2, wherein said inner support is formed from a rigid material for supporting said outer casing and said monitor unit thereon.

4. The monitor assembly as claimed in claim 2, wherein said upright post has an upper end portion disposed adjacent to said opening and formed with a fourth mounting unit which is disposed between said first mounting unit on said outer casing and said second mounting unit of said pivot connector and which is mounted securely to said first and second mounting units.

5. The monitor assembly as claimed in claim 4, wherein said outer casing has a rear side wall opposite to said front side wall, said first mounting unit including a pair of female screw rods extending forwardly from said rear side wall, each of said second and fourth mounting units having a pair of screw holes aligned respectively with said female screw rods, said monitor assembly further comprising a pair of male screw rods extending respectively through said screw holes and engaging threadedly and respectively said female screw rods for fastening securely said second mounting unit of said pivot connector and said fourth mounting unit of said upright post to said first mounting unit on said outer casing.

6. The monitor assembly as claimed in claim 1, wherein said monitor unit further includes a panel frame fastened to said rear casing member, a liquid crystal display panel disposed between said panel frame and said rear casing member, and an anchoring plate disposed between said liquid crystal display panel and said rear casing part, said anchoring plate being formed with a fifth mounting unit mounted securely to said third mounting unit of said rear casing part.

7. The monitor assembly as claimed in claim 6, wherein said pivot unit of said pivot connector includes a pair of upwardly extending insert pieces, each of which is formed with a first fastener hole, said third mounting unit of said rear casing part including a pair of second fastener holes and a pair of insert slots formed below said second fastener holes, said insert pieces of said pivot unit being inserted into said insert slots, said fifth mounting unit of said anchoring plate including a pair of third fastener holes aligned respectively with a corresponding pair of said first and second fastener holes, said monitor assembly further comprising a pair of screw fasteners extending through said first, second, and third fastener holes for mounting said pivot unit securely on said third mounting unit and for mounting said fifth mounting unit securely on said third mounting unit.

8. The monitor assembly as claimed in claim 6, wherein said anchoring plate is formed from a rigid material.

9. The monitor assembly as claimed in claim 1, wherein said pivot unit is pivotable relative to said second mounting unit about a horizontal axis that extends along a first horizontal direction.

10. The monitor assembly as claimed in claim 9, wherein said stand portion has a looped wall which defines said opening, said looped wall having a rear wall section which defines a rear periphery of said opening, and a front wall section which defines a front periphery of said opening, said pivot unit including a pair of pivot lobes which are pivoted to said second mounting unit and which are spaced apart from each other in said first horizontal direction, said pivot lobes being limited by said rear wall section and said front wall section when said pivot unit is pivoted relative to said second mounting unit.

11. The monitor assembly as claimed in claim 1, wherein said pivot unit of said pivot connector is formed with a pair of first fastener holes, said third mounting unit of said rear casing member being formed with a pair of second fastener holes, said monitor assembly further comprising a pair of screw fasteners extending through said first and second fastener holes for mounting said pivot unit securely on said rear casing member of said monitor unit.

12. The monitor assembly as claimed in claim 1, wherein said rear casing member of said monitor unit has a convex rear side wall provided with said third mounting unit, said third mounting unit being formed with a recess, said upper end portion of said stand portion extending into said recess such that said opening is concealed within said recess.
